(19) United States
(12) Patent Application Publication
(10) Pub. No.: US 2022/0192904 A1
(43) Pub. Date: Jun. 23, 2022

(54) MOBILE ASSISTIVE DEVICE AND RELATED BARRIER OVERCOMING METHOD

(71) Applicant: Wistron Corporation, New Taipei City (TW)

(72) Inventors: Ming-Ru Syue, New Taipei City (TW); Cheng-Hsing Liu, New Taipei City (TW)

(21) Appl. No.: 17/209,187

(22) Filed: Mar. 22, 2021

(30) Foreign Application Priority Data
Dec. 22, 2020 (TW) 109145377

(51) Int. Cl. A61G 5/06; A61G 5/04

(52) U.S. Cl. CPC A61G 5/06; A61G 5/04; A61G 2203/40; A61G 2203/72; A61G 2203/10

(57) ABSTRACT

A barrier overcoming method for a mobile assistive device is disclosed. The barrier overcoming method includes sensing a surrounding environment of the mobile assistive device; determining whether a dangerous terrain exists in the surrounding environment of the mobile assistive device; determining whether the dangerous terrain belongs to a conquerable obstacle when the dangerous terrain exists in the surrounding environment around the mobile assistive device; and adjusting a status of the mobile assistive device to overcome the dangerous terrain when the dangerous terrain belongs to a conquerable obstacle.

### BACKGROUND OF THE INVENTION

### 1. Field of the Invention

The present invention relates to a mobile assistive device and a related barrier overcoming method, and more particularly, to a mobile assistive device and a related barrier overcoming method capable of enlarging a utilization range by sensing a surrounding environment.

### 2. Description of the Prior Art

Conventional mobile assistive devices, such as an electric walker or electric wheelchair, may be utilized by people with low mobility. The mobile assistive device acts to avoid obstacles noticed by a user, but the utilization range of the mobile assistive device is restricted by the surrounding environment. Specifically, when the user is confronted with an object on the ground, they will operate the mobile assistive device to avoid the object by finding an alternative route, but this may require taking a detour around the object, or using a ramp when the obstacle is stairs. These alternative routes may present further problems to those with low mobility.

### SUMMARY OF THE INVENTION

The present invention provides a mobile assistive device and a related barrier overcoming method to enlarge a utilization range by sensing a surrounding environment.

An embodiment of the present invention discloses a barrier overcoming method for a mobile assistive device, comprising: sensing a surrounding environment of the mobile assistive device; determining whether a dangerous terrain exists in the surrounding environment of the mobile assistive device; when it is determined that a dangerous terrain exists, determining whether the dangerous terrain belongs to a conquerable obstacle; and adjusting a status of the mobile assistive device to overcome the dangerous terrain when the dangerous terrain belongs to the conquerable obstacle.

Another embodiment of the present invention discloses a mobile assistive device comprising: a sensing unit, configured to sense a surrounding environment of the mobile assistive device; and a processing unit, coupled to the sensing unit and configured to determine whether a dangerous terrain exists in the surrounding environment of the mobile assistive device according to the surrounding environment sensed by the sensing unit, wherein when it is determined that a dangerous terrain exists, the processing unit determines whether the dangerous terrain belongs to a conquerable obstacle , and adjusts a status of the mobile assistive device to overcome the dangerous terrain when the dangerous terrain belongs to the conquerable obstacle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a mobile assistive device according to an embodiment of the present invention.

FIGS. 2-7 are schematic diagrams of the mobile assistive device sensing a surrounding environment according to an embodiment of the present invention.

FIG. 8 is a schematic diagram of a barrier overcoming method according to an embodiment of the present invention.

### DETAILED DESCRIPTION

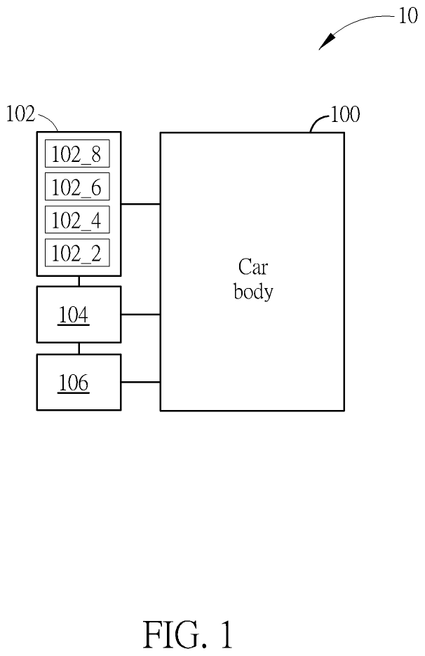

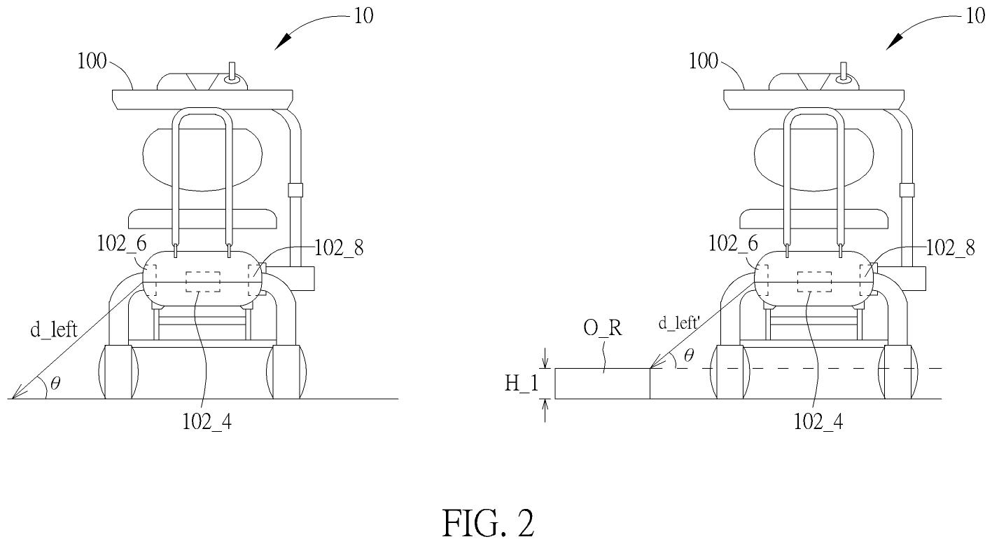

FIGS. 1 and 2 are schematic diagrams of a mobile assistive device 10 according to an embodiment of the present invention. The mobile assistive device 10 includes a car body 100, a sensing unit 102, a processing unit 104 and a motive unit 106. A back side of the mobile assistive device 10 is shown in FIG. 2. The mobile assistive device 10 may be utilized for assisting people with low mobility, e.g. people who use an electric walker or an electric wheelchair. The sensing unit 102 may include distance sensing devices 102_2 (mounted on a front side of the car body 100 and therefore not shown in FIG. 2), 102_4, 102_6 and 102_8, respectively mounted on a front, back, left and right side of the mobile assistive device 10 to sense a surrounding environment of the mobile assistive device 10. Notably, a number of the distance sensing device respectively mounted on the front, back, left and right side of the mobile assistive device 10 is not limited to one. The distance sensing devices 102_2, 102_4, 102_6, 102_8 of the mobile assistive device 10 are configured to emit sensing signals towards the ground to precisely sense obstacles on the ground. The processing unit 104 may be a processing device or a processor with computing functions, and configured to determine whether a dangerous terrain exists in the surrounding environment of the mobile assistive device 10 according to a determination by the sensing unit 102, wherein the dangerous terrain may be a raised obstacle, a drop, narrow space(s), or other obstacles on the ground that might present an unstable situation to the mobile assistive device 10.

When the processing unit 104 of the mobile assistive device 10 determines that the dangerous terrain exists in the surrounding environment of the mobile assistive device 10, the processing unit 104 may further determine whether the dangerous terrain belongs to a conquerable obstacle. The processing unit 104 of the mobile assistive device 10 may adjust a status of the mobile assistive device 10 to overcome the dangerous terrain when it is determined that the dangerous terrain belongs to a conquerable obstacle. In an embodiment, the mobile assistive device 10 may adjust a motor torque or a moving speed of the mobile assistive device 10 via the motive unit 106. In contrast, when the processing unit 104 of the mobile assistive device 10 determines that the dangerous terrain does not belong to a conquerable obstacle, the mobile assistive device 10 may include a speaker device to deliver a warning, and may also prohibit rotation of the electric wheelchair or stop the electric wheelchair from moving.

In an embodiment, the dangerous terrain is located at a side of the raised obstacle. Refer to FIG. 2, which is a schematic diagram of the mobile assistive device 10 sensing the surrounding environment according to an embodiment of the present invention. The left side of FIG. 2 illustrates the schematic diagram of the mobile assistive device 10 being in a normal moving status wherein no dangerous terrain surrounds the mobile assistive device 10. In this situation, a distance d_left and an angle θ exist between the distance sensing device 102_6 of the mobile assistive device 10 and the ground.

As shown on the right side of FIG. 2, when the sensing unit 102 of the mobile assistive device 10 senses that a dangerous terrain exists on the left side of the mobile assistive device 10 and the dangerous terrain is a raised obstacle O_R, a distance d_left′ and the angle θ exist between the distance sensing device 102_6 of the mobile assistive device 10 and the ground. The processing unit 104 is configured to determine whether the dangerous terrain belongs to a conquerable obstacle according to an obstacle height H_1 of the raised obstacle O_R, an obstacle overcoming height R_H of the mobile assistive device 10 and a gyration radius R_R of the mobile assistive device 10.

Specifically, when the obstacle height H_1 is smaller than the obstacle overcoming height R_H of the mobile assistive device 10, the processing unit 104 may determine the raised obstacle O_R is a conquerable obstacle. In contrast, when the obstacle height H_1 is larger than the obstacle overcoming height R_H of the mobile assistive device 10, the mobile assistive device 10 cannot overcome the raised obstacle O_R, and when d_{left}′×cos θ≤the gyration radius R_R, the mobile assistive device 10 will deliver a warning or prevent rotation of the electric wheelchair.

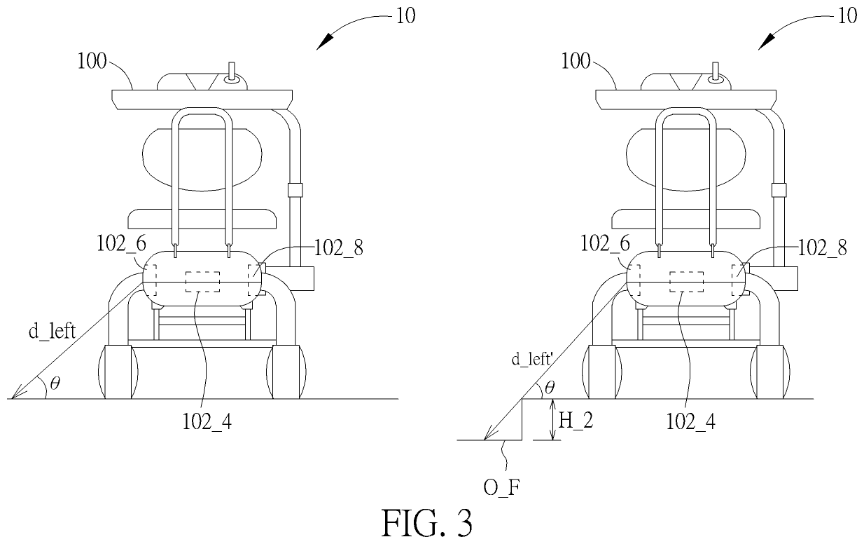

Refer to FIG. 3, which is a schematic diagram of the mobile assistive device 10 sensing surrounding environment according to another embodiment of the present invention. When the sensing unit 102 of the mobile assistive device 10 senses a dangerous terrain exists on its side and the dangerous terrain is a drop O_F, the processing unit 104 is configured to determine whether the dangerous terrain (i.e. the drop) belongs to a conquerable obstacle or not according to a drop height H_2 of the drop O_F, the obstacle overcoming height R_H of the mobile assistive device 10 and the gyration radius R_R of the mobile assistive device 10.

Specifically, when the drop height H_2 is smaller than the obstacle overcoming height R_H of the mobile assistive device 10, the processing unit 104 may determine that the drop O_F is a conquerable obstacle, the mobile assistive device 10 may smoothly drive through the drop O_F. In contrast, when the drop height H_2 is larger than the obstacle overcoming height R_H of the mobile assistive device 10, the mobile assistive device 10 cannot overcome the drop O_F, and the mobile assistive device 10 delivers the warning or stops the electric wheelchair from moving.

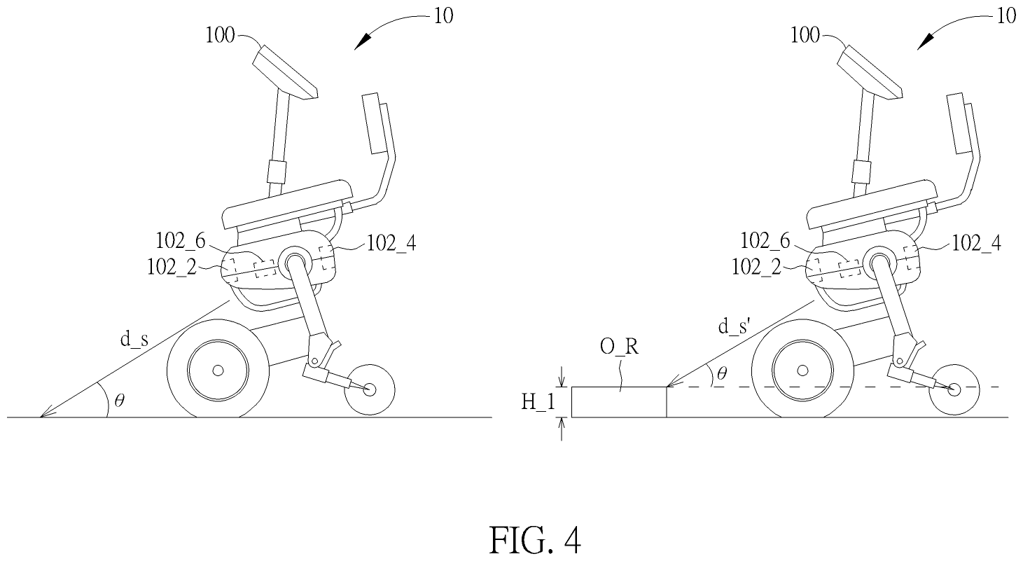

The above illustrates examples of dangerous terrain sensed by the distance sensing device of the mobile assistive device 10. Refer to FIG. 4, which is a schematic diagram of the mobile assistive device 10 sensing a dangerous terrain in front of the mobile assistive device 10 according to an embodiment of the present invention. The left side of FIG. 4 illustrates the mobile assistive device 10 being in a normal moving status without any dangerous terrain surrounding the mobile assistive device 10. In this situation, a distance d_s and an angle θ exist between the distance sensing device 102_2 of the mobile assistive device 10 and the ground.

As shown on the right side of FIG. 4, when the sensing unit 102 of the mobile assistive device 10 senses that a dangerous terrain exists in front of the mobile assistive device 10 and the dangerous terrain is a raised obstacle O_R, a distance d_s′ and the angle θ exist between the distance sensing device 102_2 of the mobile assistive device 10 and the ground. The processing unit 104 is configured to determine whether the dangerous terrain belongs to a conquerable obstacle according to the obstacle height H_1 of the raised obstacle O_R, the obstacle overcoming height R_H of the mobile assistive device 10 and the gyration radius R_R of the mobile assistive device 10.

Therefore, when the obstacle height H_1 is smaller than the obstacle overcoming height R_H of the mobile assistive device 10, the processing unit 104 may determine that the raised obstacle O_R is a conquerable obstacle. In contrast, when the obstacle height H_1 is larger than the obstacle overcoming height R_H of the mobile assistive device 10, the mobile assistive device 10 cannot overcome the raised obstacle O_R, and when d_s′×cos θ≤the gyration radius R_R, the mobile assistive device 10 will deliver a warning or stop the electric wheelchair from moving.

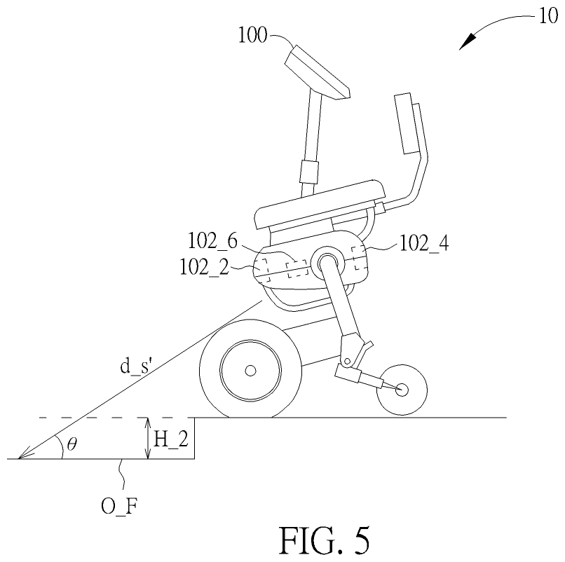

Refer to FIG. 5, which is a schematic diagram of the mobile assistive device 10 sensing surrounding environment according to another embodiment of the present invention. When the sensing unit 102 of the mobile assistive device 10 senses that a dangerous terrain is in front of the mobile assistive device 10 and the dangerous terrain is a drop O_F, the processing unit 104 is configured to determine whether the dangerous terrain (i.e. the drop) belongs to a conquerable obstacle according to the drop height H_2 of the drop O_F, the obstacle overcoming height R_H of the mobile assistive device 10 and the gyration radius R_R of the mobile assistive device 10.

When the drop height H_2 is smaller than the obstacle overcoming height R_H of the mobile assistive device 10, the processing unit 104 may determine that the drop O_F is a conquerable obstacle, and the mobile assistive device 10 may drive smoothly through the drop O_F. In contrast, when the drop height H_2 is larger than the obstacle overcoming height R_H of the mobile assistive device 10, the mobile assistive device 10 cannot conquer the drop O_F. In this situation, the mobile assistive device 10 delivers a warning, stops the device from moving or prohibits rotation over 90° to avoid dangers. Similarly, when the mobile assistive device 10 reverses, the above detection method may be utilized to sense the surrounding environment behind the device.

When the dangerous terrain sensed by the mobile assistive device 10 is a conquerable obstacle, the processing unit 104 of the mobile assistive device 10 may adjust the motor torque and the moving speed of the mobile assistive device 10 via the motive unit 106 to conquer the dangerous terrain surrounding the mobile assistive device 10.

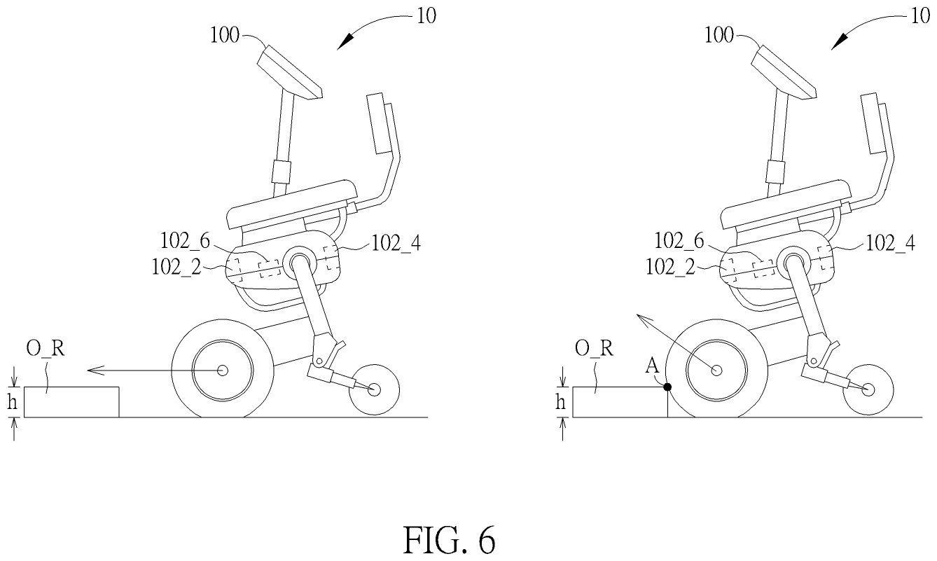

In detail, when the processing unit 104 of the mobile assistive device 10 determines that the dangerous terrain is conquerable, the processing unit 104 may determine the motor torque of the mobile assistive device 10 according to conservation of angular momentum and conservation of mechanical energy. Refer to FIG. 6, which is a schematic diagram of the mobile assistive device 10 sensing a surrounding environment according to an embodiment of the present invention. Assume that a weight of a wheel body of the mobile assistive device 10 is m, an initial velocity of the wheel body is v, a radius of the wheel body is r, a moment of inertia of the wheel body is I, the obstacle height is h and an instantaneous angular velocity when overcoming the barrier is ω′. Formulas (1) and (2) may be obtained according to the conservation of angular momentum and the conservation of mechanical energy, when the mobile assistive device 10 hits an impact point A of the raised obstacle O_R:

$$\begin{matrix}mv ( r - h ) + I ( \frac{v}{r} ) = {mr}^{2} {ω}^{′} + I {ω}^{′} & ( 1 ) \\ \frac{1}{2} ( {mr}^{2} + I ) {ω}^{′2} = mgh & ( 2 )\end{matrix}$$

Further, a minimal velocity v of formula (3) for the mobile assistive device 10 to overcome the barrier may be deduced according to formulas (1) and (2):

$$v = \frac{( m {τ}^{2} + I ) \sqrt{m g h / \frac{1}{2} ( {mr}^{2} + I )}}{m ( r - h ) + I ( \frac{1}{r} )} \qquad ( 3 )$$

Therefore, the mobile assistive device 10 may adjust the motor torque or speed of the mobile assistive device 10 according to the motor torque determined by the processing unit 104 corresponding to different dangerous terrains, in order to conquer the dangerous terrain. Testing the wheel velocity or motor torque in advance for different types of wheels of the mobile assistive device 10, e.g. universal wheel, is required to conquer the obstacles smoothly.

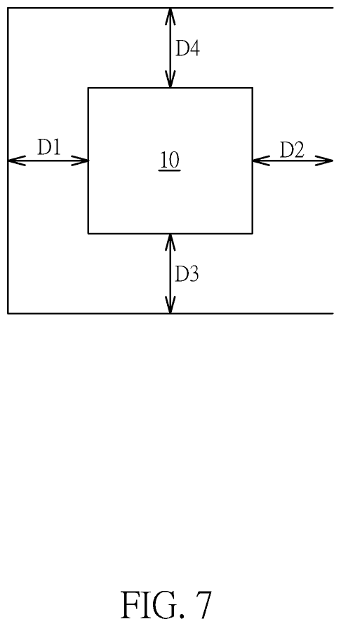

Refer to FIG. 7, which is a schematic diagram of the mobile assistive device 10 sensing surrounding environment according to an embodiment of the present invention. When the mobile assistive device 10 enters a narrow space, it is difficult for a user to get out of the narrow space easily. Therefore, when the sensing unit 102 of the mobile assistive device 10 senses that the dangerous terrain is a narrow space, the mobile assistive device 10 is configured to determine whether the dangerous terrain is a conquerable obstacle according to the gyration radius R_R of the mobile assistive device 10.

Specifically, the processing unit 104 may determine whether the obstacle is conquerable according to a nearest distance between an object and the mobile assistive device 10. For example, in the embodiment of FIG. 7, the mobile assistive device 10 may determine whether the obstacle is conquerable according to distances D1-D4 between the object and the mobile assistive device 10: if the distances D1-D4 between the objects and the mobile assistive device 10 are all larger than the gyration radius R_R of the mobile assistive device 10, the processing unit 104 may arbitrarily rotate to get out of the narrow space. In addition, a maximal distance among the distances D1-D4 between the mobile assistive device 10 and the objects is determined, representing no wall or no obstacles. The mobile assistive device 10 may move in a direction with the maximal distance, or the mobile assistive device 10 may rotate clockwise or counterclockwise till at least two directions out of the front, back, left and right of the mobile assistive device 10 are larger than a default distance to get out of the narrow space. Alternatively, the mobile assistive device 10 may first rotate clockwise/counterclockwise 90° and then sense the surrounding height and obstacle to determine a best way to get out of the narrow space.

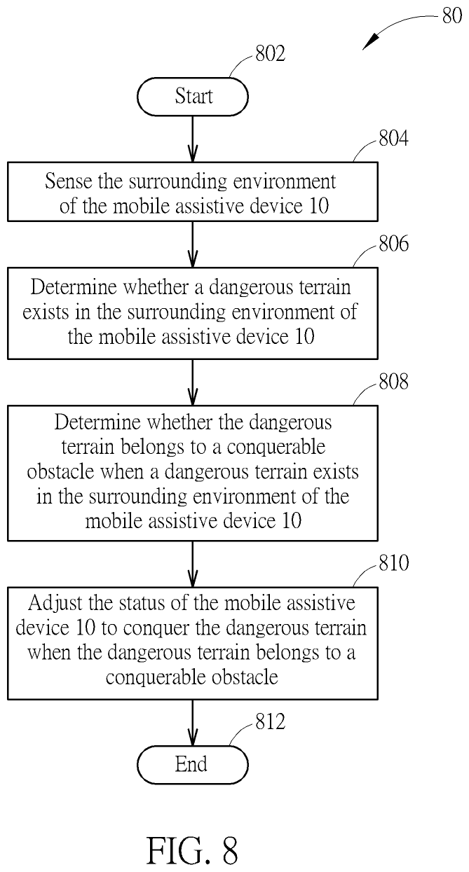

The barrier overcoming method of the mobile assistive device 10 may be summarized by a barrier overcoming method 80, as shown in FIG. 8. The barrier overcoming method 80 includes the following steps:

Step 802: Start.

Step 804: Sense the surrounding environment of the mobile assistive device 10.

Step 806: Determine whether a dangerous terrain exists in the surrounding environment of the mobile assistive device 10.

Step 808: Determine whether the dangerous terrain belongs to a conquerable obstacle when a dangerous terrain exists in the surrounding environment of the mobile assistive device 10.

Step 810: Adjust the status of the mobile assistive device 10 to conquer the dangerous terrain when the dangerous terrain belongs to a conquerable obstacle.

Step 812: End.

Further details about the operation method of the barrier overcoming method 80 are provided by the embodiments of the mobile assistive device 10 above, and therefore not narrated here for brevity.

Notably, the embodiments of the present invention illustrated above may be properly modified by people skilled in the art, and not limited thereto. For example, an amount of the distance sensing device mounted on each side of the mobile assistive device, conditions of determining the minimal velocity of overcoming the barrier and ways to get out of the narrow space are not limited to the above embodiments, and may be modified according to adjustments of a user or a manufacturer. These modifications are applicable to the present invention.

In summary, a mobile assistive device and a barrier overcoming method according to an embodiment of the present invention sense obstacles in the surrounding environment to determine whether the obstacle is conquerable. A utilization range of the mobile assistive device is thereby enlarged.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A barrier overcoming method for a mobile assistive device, comprising:
sensing a surrounding environment of the mobile assistive device;
determining whether a dangerous terrain exists in the surrounding environment of the mobile assistive device;
determining whether the dangerous terrain belongs to a conquerable obstacle when the dangerous terrain exists in the surrounding environment around the mobile assistive device; and
adjusting a status of the mobile assistive device to overcome the dangerous terrain when the dangerous terrain belongs to a conquerable obstacle.

2. The barrier overcoming method of claim 1, further comprising:
the mobile assistive device delivering a warning, prohibiting rotation or stopping movement of the mobile assistive device when the dangerous terrain is not a conquerable obstacle.

3. The barrier overcoming method of claim 1, wherein the dangerous terrain is a raised obstacle, a drop or a narrow space.

4. The barrier overcoming method of claim 3, wherein when the mobile assistive device senses that the dangerous terrain exists on a side of the mobile assistive device and the dangerous terrain is the raised obstacle, the mobile assistive device is configured to determine whether the dangerous terrain is a conquerable obstacle according to an obstacle height of the raised obstacle, an obstacle overcoming height of the mobile assistive device, and a gyration radius of the mobile assistive device.

5. The barrier overcoming method of claim 3, wherein when the mobile assistive device senses that the dangerous terrain exists on a side of the mobile assistive device and the dangerous terrain is the drop, the mobile assistive device is configured to determine whether the dangerous terrain is a conquerable obstacle according to a drop height of the drop, an obstacle overcoming height of the mobile assistive device and a gyration radius of the mobile assistive device.

6. The barrier overcoming method of claim 3, wherein when the mobile assistive device senses that the dangerous terrain exits on the front or rear of the mobile assistive device and the dangerous terrain is the raised obstacle, the mobile assistive device is configured to determine whether the dangerous terrain is a conquerable obstacle according to an obstacle height of the raised obstacle, an obstacle overcoming height of the mobile assistive device and a gyration radius of the mobile assistive device.

7. The barrier overcoming method of claim 3, wherein when the mobile assistive device senses that the dangerous terrain exists on the front or rear of the mobile assistive device and the dangerous terrain is the drop, the mobile assistive device is configured to determine whether the dangerous terrain is a conquerable obstacle according to a drop height of the drop, an obstacle overcoming height of the mobile assistive device and a gyration radius of the mobile assistive device.

8. The barrier overcoming method of claim 3, wherein when the mobile assistive device senses that the located dangerous terrain is the narrow space, the mobile assistive device is configured to determine whether the dangerous terrain is a conquerable obstacle according to a gyration radius of the mobile assistive device.

9. The barrier overcoming method of claim 3, wherein the step of adjusting the status of the mobile assistive device to conquer the dangerous terrain when the dangerous terrain is a conquerable obstacle comprises:
when the dangerous terrain belongs to the raised obstacle, the mobile assistive device is configured to determine a torque of the mobile assistive device to conquer the dangerous terrain according to an impact point of the mobile assistive device and the raised obstacle and an obstacle height of the raised obstacle.

10. A mobile assistive device, comprising:
a sensing unit, configured to sense a surrounding environment of the mobile assistive device; and
a processing unit, coupled to the sensing unit and configured to determine whether a dangerous terrain exists in the surrounding environment of the mobile assistive device according to the surrounding environment sensed by the sensing unit, determine whether the dangerous terrain belongs to a conquerable obstacle when the dangerous terrain exists in the surrounding environment, and adjust a status of the mobile assistive device to overcome the dangerous terrain when the dangerous terrain belongs to a conquerable obstacle.

11. The mobile assistive device of claim 10, wherein the mobile assistive device is configured to deliver a warning, prohibit rotation or stop movement of the mobile assistive device, when the dangerous terrain does not belong to a conquerable obstacle.

12. The mobile assistive device of claim 10, wherein the dangerous terrain is a raised obstacle, a drop or a narrow space.

13. The mobile assistive device of claim 12, wherein when the sensing unit of the mobile assistive device senses that the dangerous terrain exists on a side of the mobile assistive device and the dangerous terrain belongs to the raised obstacle, the processing unit is configured to determine whether the dangerous terrain belongs to a conquerable obstacle according to an obstacle height of the raised obstacle, an obstacle overcoming height of the mobile assistive device, and a gyration radius of the mobile assistive device.

14. The mobile assistive device of claim 12, wherein when the sensing unit of the mobile assistive device senses that the dangerous terrain exists on a side of the mobile assistive device and the dangerous terrain belongs to the drop, the processing unit is configured to determine whether the dangerous terrain belongs to a conquerable obstacle according to a drop height of the drop, an obstacle overcoming height of the mobile assistive device and a gyration radius of the mobile assistive device.

15. The mobile assistive device of claim 12, wherein when the sensing unit of the mobile assistive device senses that the dangerous terrain exits on the front or rear of the mobile assistive device and the dangerous terrain belongs to the raised obstacle, the processing unit is configured to determine whether the dangerous terrain belongs to a conquerable obstacle according to an obstacle height of the raised obstacle, an obstacle overcoming height of the mobile assistive device and a gyration radius of the mobile assistive device.

16. The mobile assistive device of claim 12, wherein when the sensing unit of the mobile assistive device senses that the dangerous terrain exists on the front or rear of the mobile assistive device and the dangerous terrain belongs to the drop, the processing unit is configured to determine whether the dangerous terrain belongs to a conquerable obstacle according to a drop height of the drop, an obstacle overcoming height of the mobile assistive device and a gyration radius of the mobile assistive device.

17. The mobile assistive device of claim 12, wherein when the sensing unit of the mobile assistive device senses that the located dangerous terrain belongs to the narrow space, the mobile assistive device is configured to determine whether the dangerous terrain belongs to a conquerable obstacle according to a gyration radius of the mobile assistive device.

18. The mobile assistive device of claim 12, wherein when the dangerous terrain belongs to the raised obstacle, the processing unit is configured to determine a torque of the mobile assistive device according to an impact point of the mobile assistive device and the raised obstacle, an obstacle height of the raised obstacle, and a motive unit of the mobile assistive device is configured to conquer the dangerous terrain based on the torque determined by the processing unit.
